(19) United States
(12) Patent Application Publication
(10) Pub. No.: US 2018/0206017 A1
(43) Pub. Date: Jul. 19, 2018

(54) Stand Base

(71) Applicant: The Music People, Inc., Berlin, CT (US)

(72) Inventors: James Robinson, Wolcott, CT (US); Christopher A. Roberts, West Hartford, CT (US); James R. Hennessey, West Hartford, CT (US)

(73) Assignee: The Music People, Inc., Berlin, CT (US)

(21) Appl. No.: 15/406,238

(22) Filed: Jan. 13, 2017

(51) Int. Cl. H04R 1/08; F16M 11/28; F16M 11/32; A47B 19/00

(52) U.S. Cl. CPC H04R 1/08; F16M 11/28; F16M 2200/08; A47B 19/002; A47B 2019/008; F16M 11/32

(57) ABSTRACT

A stand base includes a low-profile body with a top side, bottom side and faces connecting the bottom side to the top side; at least one fastener positioned at the top side and configured to couple a shaft to the body in a raised orientation; and a solid flat primary plate extending out from one of the faces. The top side, bottom side and faces each have a planar surface. The primary plate has an upper surface and lower surface that are planar, the lower surface of the primary plate and the bottom surface of the body providing an even ground-engaging surface. A height of the primary plate is less than a height of the body. A solid flat secondary plate is also disposed on a side of the body opposite from the primary plate, a height of the secondary plate being less than the height of the body.

### TECHNICAL FIELD

The present teachings relate generally to an apparatus for supporting a stand, such as a microphone stand, music stand, speaker stand, or the like. More specifically, the present teachings relate to a low-profile stand base that has increased surface area contact with the ground and provides for multiple objects to be supported and oriented independently of one another relative to the stand base.

### BACKGROUND

Conventional stands are typically designed with a base and a single shaft attached thereto for holding an object, such as a microphone in the context of a microphone stand or a music rest for holding sheets of music in the context of a music stand. Some conventional stands include a weighted, dome-shaped round base. As a result of the dome-shape, the base has a relatively high profile, which does not allow for the stand to be positioned partially underneath other sound equipment (e.g., music equipment, amplifier). The dome-shaped base requires ample height clearance (free space) in order to avoid any interference or obstruction to the stand. Further, to ensure that the stand does not tip over when an object is mounted thereto, the base is often weighted. However, the weighted base does not allow for easy packing or transport of the stand.

Another type of conventional stand consists of a leg base having multiple legs/feet extending diagonally towards the ground (e.g., tri-pod base, quad-pod base). However, these conventional stands possess the same disadvantages of a high-profile base. The points where the legs connect to the shaft of the stand are often elevated above the ground by a substantial amount. With this elevated configuration, the stand may be prone to instability and tipping issues, especially when an object of substantial weight is held by a tall shaft.

The leg base can sometimes fold against the shaft for purposes of transport. The leg base may also weigh less compared to dome-shaped bases. In order for the leg base to maintain stability with its reduced weight, each individual leg must extend beyond the radius of a round, dome-shaped base. This causes the leg base stand to have a wider base profile, which prevents the stand from being positioned close to a person (e.g., musician, vocalist) and/or underneath other structure or equipment (e.g., audio/sound equipment, amplifier). In addition, the legs may become a trip-hazard.

Conventional stands are also disadvantageous in that they are configured with only one shaft, which is capable of holding only one object (e.g., microphone, speaker, tablet). The bases of conventional stands are not multi-functional and do not allow for multiple shafts and multiple objects to be mounted thereto.

Also, in typical stage setups, an amplifier has multiple stands with multiple microphones to pick up the complete sound coming from the amplifier. This is disadvantageous because stage real-state is often limited, and the more microphone stands there are on the stage, the less space there is for performers (e.g., singers, musicians) to move. The performers are therefore restrained in being able to freely move around the stage.

In addition, musicians such as electric guitarists often mic an amplifier (e.g., guitar amp) because they want to achieve a desired sound within a venue and/or because the PA/loudspeaker system of the venue has a different input/output, thereby preventing direct connection of the amplifier. One typical arrangement for miking an amplifier involves hanging or dangling the microphone by its cable from the top of the amplifier (FIG. 12). However, this arrangement applies undue stress-strain on the microphone cable and does not allow for precise positioning of the microphone relative to the amplifier speaker (necessary for obtaining a specific sound desired by the musician). Another typical arrangement involves placing a microphone stand in front of the amplifier (FIG. 13). However, in this arrangement, the high-profile base does not allow for the stand to be positioned near the amplifier. A significant amount of clearance space in front of the amplifier is required for the microphone stand to be assembled. As a result, optimal placement of the microphone near to the amplifier's speaker may be inhibited. Moreover, stage real estate is limited, and the typical arrangement of the amplifier and microphone stand, as shown in FIG. 13, would further reduce the amount of free space in which the musician(s) can move. This drawback is exacerbated when multiple stands with multiple microphones are used to pick up the complete sound from a single amplifier.

In some situations, vibrations and/or shocks may shake the ground underneath the base, thereby transferring the vibrations through the microphone stand and moving the position of the microphone relative to the amplifier. The vibrations experienced by the microphone would degrade the quality of sound picked up by the microphone from the amplifier and thereby transmit poor audio to the PA/loudspeaker during a performance.

While some stands may provide some improvements over conventional stands, they still suffer from several disadvantages, including instability and being prone to tipping. Another disadvantage is that the stands still require substantial clearance space and thus cannot be positioned close to, for example up against or underneath, other sound equipment (e.g., amplifiers, speakers).

### SUMMARY

The needs set forth herein as well as further and other needs and advantages are addressed by the present embodiments, which illustrate solutions and advantages described below.

An objective of the present teachings is to remedy the above problems associated with the base of a stand, such as that of a microphone stand. Another objective of the present teachings is to provide a stand base which requires less space and is more efficient with respect to time needed for assembly and disassembly. Another objective of the present teachings is to provide a base which increases/improves the stability of a stand and reduces the likelihood of tipping. A further objective of the present teachings is to provide a low-profile base requiring minimal height clearance space, thereby allowing for the base to slide at least partially under another structural object. An additional objective of the present teachings is to provide a low-profile base which enables another structural object to be placed on top of a portion of the stand and accordingly makes the base weighted. Still, another objective of the present teachings to provide a single base configured to support multiple shafts.

The present teachings provide a stand base comprising a low-profile body with a top side, a bottom side opposite the top side and faces connecting the bottom side to the top side, wherein each of the sides and faces of the body has a substantially planar surface. The stand base includes at least one fastener positioned at the top side of the body and configured to couple at least one shaft to the body in a raised orientation. A solid, flat primary plate extends out from one of the faces of the body, wherein the primary plate has an upper surface and a lower surface that are substantially planar. The lower surface of the primary plate and the bottom surface of the bottom side of the body provide an even ground-engaging surface. The height of the primary plate from the lower surface to the upper surface is less than a height of the body from the bottom surface to the top surface.

The stand base may also include a solid secondary plate disposed on a side of the body opposite the primary plate and extends out from another one of the faces of the body. The secondary plate has an upper surface and a lower surface that are substantially planar, wherein the lower surface of the secondary plate is even with the bottom surface of the body. A height of the secondary plate from the lower surface to the upper surface of the secondary plate is less than a height of the body from the bottom surface to the top surface of the body.

Other objectives are achieved by providing a stand base comprising a low-profile body with a top side, a bottom side opposite the top side and faces connecting the bottom side to the top side, wherein each of the sides and faces of the body has a substantially planar surface. The stand base includes a plurality of fasteners positioned at the top side of the body, each fastener being configured to independently couple a shaft to the body in a raised orientation. A solid, flat primary plate extends out from one of the faces of the body, wherein the primary plate has an upper surface and a lower surface that are substantially planar. The lower surface of the primary plate and the bottom surface of the bottom side of the body provide an even ground-engaging surface. The height of the primary plate from the lower surface to the upper surface is less than a height of the body from the bottom surface to the top surface. In some embodiments, the fasteners are spaced apart from one another by a distance that is equal to or greater than a diameter of the shaft (or a diameter of the fasteners). In some embodiments, the fasteners are collinear.

Further objectives are achieved by providing a stand assembly comprising multiple shafts each having a proximal end and a distal end, and a single base. The base includes a low-profile body with a top side, a bottom side opposite the top side and faces connecting the bottom side to the top side, wherein each of the sides and faces of the body has a substantially planar surface. A plurality of fasteners are positioned at the top side of the body and spaced apart from one another by a distance that is equal to or greater than a diameter of the shafts. The proximal end of each shaft is releasably connected to one of the plurality of fasteners to support the shaft in an upright position. A solid, flat primary plate extends out from one of the faces of the body, wherein the primary plate has an upper surface and a lower surface that are substantially planar. The lower surface of the primary plate and the bottom surface of the bottom side of the body provide a continuous even ground-engaging surface. The height of the primary plate from the lower surface to the upper surface is less than a height of the body from the bottom surface to the top surface.

Other features and aspects of the invention will become apparent from the following detailed description, taken in conjunction with the accompanying drawings, which illustrate by way of example, the features in accordance with embodiments of the invention. The summary is not intended to limit the scope of the invention, which is defined solely by the claims attached thereto.

### BRIEF DESCRIPTION OF THE DRAWINGS

FIG. 1 depicts a top perspective view of a stand in accordance with the present teachings.

FIG. 2 depicts an exploded view of a stand of FIG. 1.

FIGS. 3A-3E depict detailed views of the base of the stand of FIG. 1.

FIGS. 4A-4B depict the stand of FIG. 1 being used to support one or more microphones for miking one or more amplifiers.

FIG. 5 depicts a detailed view of foot pads installed on a bottom surface of the base of the stand of FIG. 1.

FIGS. 6-11 depict detailed views of different portions of the support shaft of the stand of FIG. 1.

FIG. 12 depicts a prior art arrangement for miking one or more amplifiers.

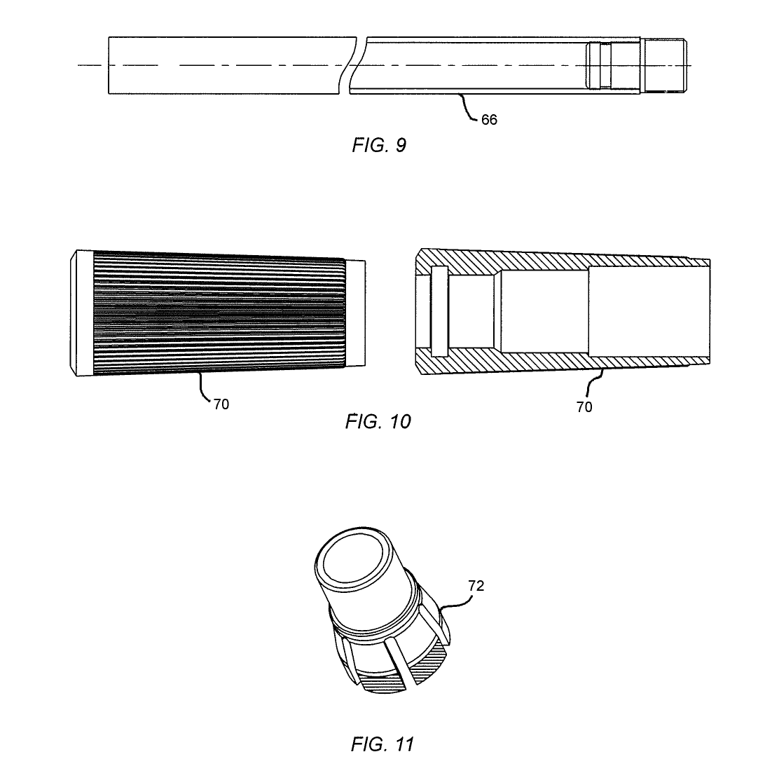

FIG. 13 depicts another prior art arrangement for miking one or more amplifiers.

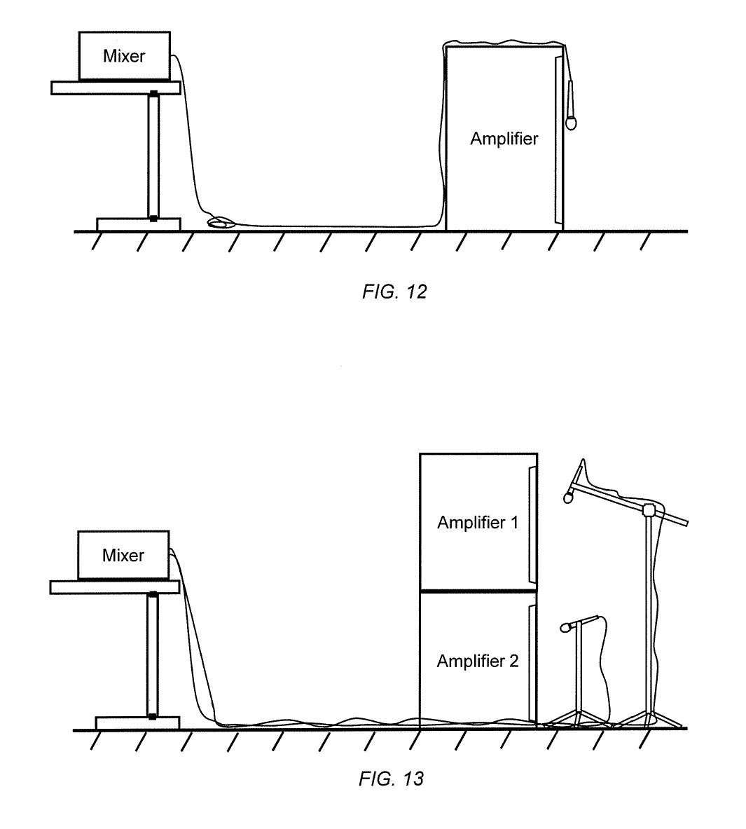

### DETAILED DESCRIPTION

The present teachings are described more fully hereinafter with reference to the accompanying drawings, in which the present embodiments are shown. The following description illustrates the present teachings by way of example, not by way of limitation of the principles of the present teachings.

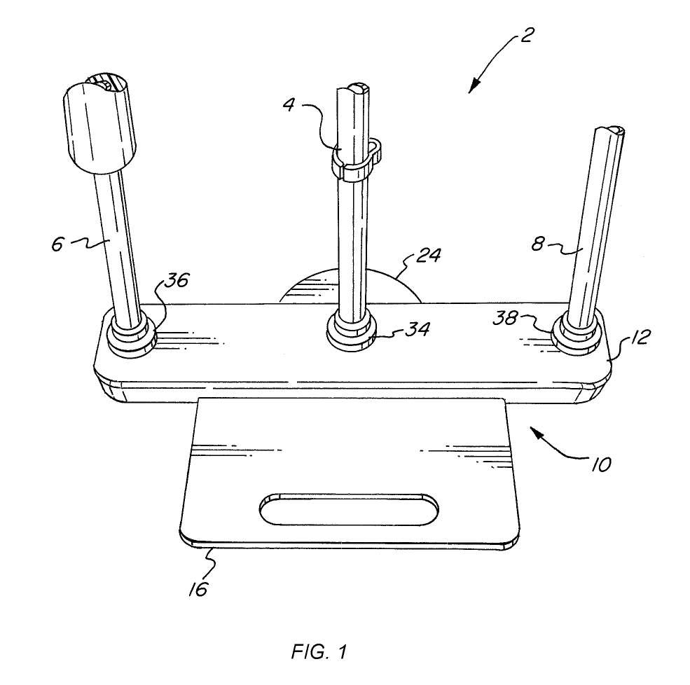

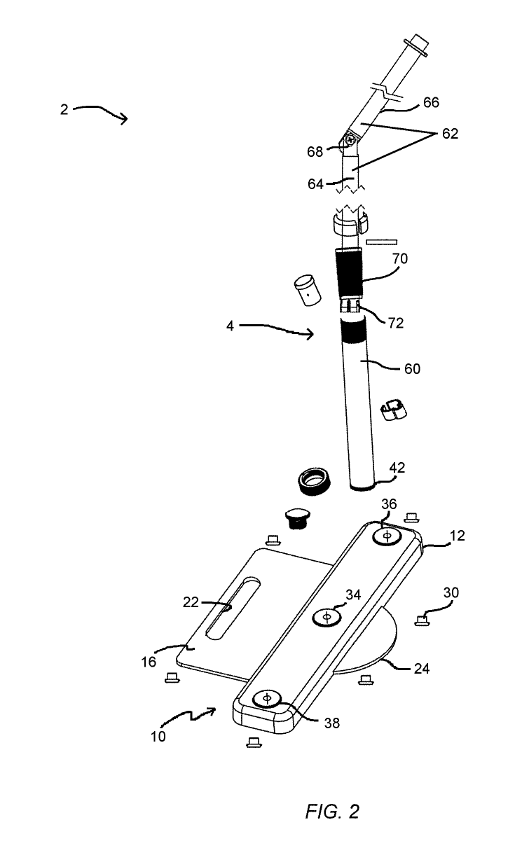

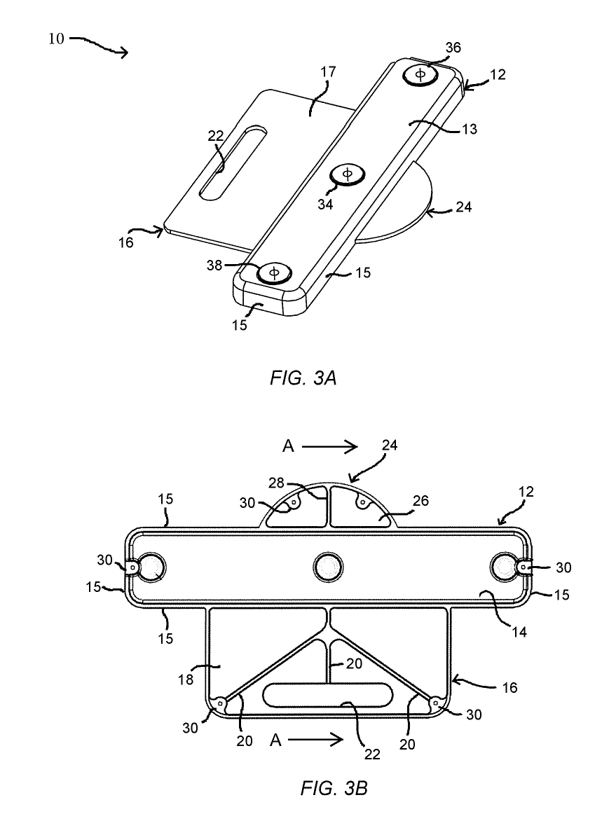

FIGS. 1-2 illustrate a stand 2, and more specifically a multi-purpose stand 2 designed to support one or more shafts 4, 6, 8. The stand 2 comprises a ground-engaging base 10, which differs from conventional podal bases (e.g., tri-pod, quad-pod) and round, dome-shaped bases. The base 10 includes a main body 12. As shown in FIGS. 3A-3D, the body 12 has a top side, bottom side and faces connecting the top side to the bottom side. The exterior shape created by the top side and faces of the body resembles a prismatoid and more specifically a rectangular frustrum. However, the body 12 may comprise other shapes, for example the shape of a rectangular prism, hexagonal frustrum, hexagonal prism, octagonal frustrum, or octagonal prism. The body 12 may also be designed with rounded corners and/or edges (FIGS. 3A-3E). The top side of the body is configured to be horizontal and substantially parallel to the ground on which the base sits.

In some embodiments, the body 12 is formed as a solid piece that is weighted. For example, the body 12 may be constructed out of a single piece of metal, such as steel, using sand casting or another metal casting process. Other metallic materials that are dense may be used in constructing the weighted body 12. Alternatively, the body 12 may comprise a plastic exterior housing with a solid metal block disposed inside the plastic housing. The solid, weighted body 12 provides a stable and sturdy foundation for supporting the one or more shafts 4, 6, 8.

In other embodiments, the body 12 may be hollow and accordingly weigh less than the solid, weighted configuration. A portion of the bottom side of the body 12 may be recessed such that a hollow concave cavity (interior) with an opening in the bottom side is formed in the body, as shown in FIG. 3C. Despite the lighter weight, the hollow body 12 is capable of being stable and sturdy for purposes of supporting the shafts 4, 6, 8. The hollow body may be constructed from a metal material (e.g., steel), plastic, or a combination thereof. The hollow body is advantageous because it allows easier packing of the stand when moving from location to location.

The body 12 is dimensioned to have a low-profile so that the base 10 can be slid, at least partially, under audio/sound equipment or other objects (e.g., desks, tables). This allows for closer positioning of the shaft(s) and, for example, microphone(s) attached to the shaft(s). The top surface 13 of the body 12 is flat and substantially horizontal or parallel to the ground on which the base sits. The height of the body 12, as best seen in FIGS. 3C-3E, may be less than 2 inches. In some embodiments, the height of the body 12 may be less than 1.5 inches or further less than 1.25 inches. One example of the body 12 measures approximately 1.22 inches or 31 mm high. The length of the body 12, from one end to an opposing end, is around 18 inches or 455.05 mm, which provides sufficient spacing between each of the shafts 4, 6, 8 (FIGS. 3B and 3E). In some embodiments, the length of the body 12 may be further reduced so that it takes us less room (e.g., stage real estate) and is more convenient to pack and transport. In other embodiments, especially where the base 10 is configured to support more than three shafts, the main body may be longer than 18 inches so that the shafts are spaced apart by an adequate distance. Each shaft, as shown in FIGS. 1-2, is spaced apart from one another by a distance equal to or greater than the diameter of the shafts or the diameter of the fasteners 34, 36, 38.

Although the main body 12 has been described above with exemplary shapes, sizes and weights, the body of the base may be characterized by different combinations of shapes, sizes and weights which provide a low-profile and make the base stable for supporting at least one tall shaft and at least one boom arm that may be cantilevered off the top of the tall shaft.

As shown in FIGS. 3A-3E, the perimeter of the main body 12 is composed of rounded corners and edges and flat side (facial) surfaces 15. The side surfaces are orientated substantially perpendicular relative to the top surface 13 of the main body 12. Alternatively, the side surfaces 15 may be slanted such that the angle between a side surface 15 and the top surface 13 is slightly more than 90 degrees (FIGS. 3C-3D). The flat and planar surfaces of the base 10 contrasts conventional stands which comprise either a rounded, dome-shaped base or a podal base. This configuration of the present teachings makes the stand more stable and resistant to tipping over.

The base 10 further comprises a solid extension plate 16 to provide further stability to the main body and to prevent tipping of the main body and the stand as whole. The extension plate 16 extends out from one side of the main body 12, as shown in FIGS. 3A-3B. Where the main body 12 is rectangular, the extension plate 16 is positioned along one of the two longer sides of the body. In some embodiments, the proximal side of the extension plate is connected to the main body so that it extends perpendicularly relative to the corresponding side surface 15. In other embodiments, the extension plate 16 and the corresponding side surface 15 form an angle slightly greater than 90 degrees therebetween.

The extension plate 16 comprises a flat, planar top surface 17 as shown in FIGS. 3A and 3C-3E. The extension plate may be designed in the shape of a rectangle (looking down at the top surface), wherein one of the longer sides forms the proximal end connected to the main body 12 and the other, opposing longer side forms a free distal end. FIGS. 3C-3D depict the extension plate 16 as having a substantially shorter height than that of the main body 12. For example, the extension plate 16 has a height less than or equal to ½ inch. In a preferred embodiment, the height of the extension plate 16 is approximately ¼ inch or 6 mm. The length of the extension plate 16, from one shorter side to the other shorter side, is also smaller than the length of the main body 12 (FIG. 3E). For example, the length of the extension plate may be approximately 11 inches or 275 mm. However, the length of the extension plate may be further reduced, thereby making the base 10 more compact. In some embodiments, the length of the extension plate 16 may be determined as a percentage or ratio of the length of the main body 12. For example, the extension plate may stretch anywhere between ½ and ¾ of the length of the main body.

The width of the extension plate 16, from its proximal end to its distal end, is greater than the width of the main body 12. Specifically, the extension plate 16 extends out from the body 12 by an amount which is greater that the distance between the opposing longer side surfaces of the body 12. In FIGS. 3C-3D, the width of the extension piece 16 is approximately 5 inches or 125 mm. However, the width of the extension plate may be reduced, thereby making the base 10 more compact. The extension plate is configured to provide additional stability and support to the main body to further ensure that the stand does not tip over due to the weight of the shaft(s) and objects attached to the shafts (e.g., boom arms, microphones, tablets, audio recorders, music rest, etc.). The width of the extension plate is proportional or at least related to the stability it imparts to the body 12. As such, if the extension plate is widened, it increases stability of the base and further prevents the body—and the stand as a whole—from tipping. It is noted that even if the width of the extension plate is reduced, the extension plate still makes the body more stable than without it.

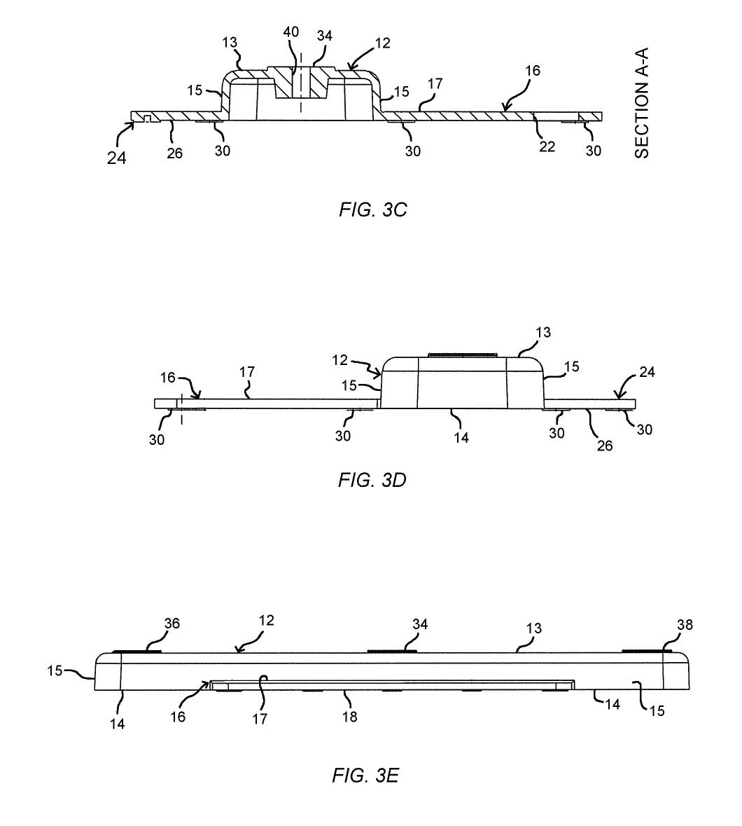

Given the shape and dimensions of the extension plate 16, this part of the base is characterized with a low-profile such that it can be slid, partially or entirely, under audio/sound equipment (e.g., amplifier, speakers, other stands) or other objects (e.g., desks, tables), as shown in FIG. 4A. In some cases, the extension plate 16 may be stacked below audio/sound equipment (FIG. 4B). Because the extension plate is short and does not rise substantially above the ground, audio/sound equipment (e.g., amplifiers, speakers, other stands) may be set on top of the extension plate without substantially affecting the level, balance and/or stability of the audio/sound equipment. The extension plate 16 is further configured to exploit and take advantage of the weight of the object(s) stacked on top of it by augmenting the weight of the base. That is, the extension plate is adapted to transmit the downward force exerted by the weight of the object(s) to the main body 12, thereby securing the body 12 in place and inhibiting movement—including tipping and swaying—of the base 10. Additionally, if the main body 12 is hollow, the weight of the objects stacked on top of the extension plate transforms the base into a weighted base.

Although FIGS. 3A-3E show that the extension plate 16 has a rectangular shape with rounded corners, the extension plate may comprise other shapes. In some embodiments, the distal end of the extension plate 16 may be beveled. The sides of the extension plate between the proximal end and the distal end may also be beveled. In other embodiments, the extension plate may resemble a wedge wherein the top surface 17 gradually slants down from the proximal end to the distal end of the extension plate. These particular configurations may improve the ease with which the extension plate may be slid underneath audio/sound equipment (e.g., amplifier, speakers, other stands) or other objects (e.g., desks, tables). Alternatively, the extension plate may be semicircular or triangular in shape, and/or comprise rounded or curved sides. Irrespective of its shape and dimensions, the extension plate 16 may be permanently attached to the main body 12 (e.g., soldered, brazed, welded, or molded together). In other embodiments, the extension plate 16 may be a separate component that releasably connects to the main body 12. By providing a releasable connection between the extension plate 16 and the main body 12, the base—and the stand as a whole—can be disassembled into smaller pieces made easier for packing and transporting.

In some embodiments, the bottom surface 18 of the extension plate 16 is even and flush with the bottom surface 14 of the main body 12, thereby providing an uninterrupted, planar surface which engages the ground or floor (FIGS. 3C-3E). The bottom surface 18 may also comprise one or more struts or posts 20 to form a planar truss embedded in the surface. As shown in FIG. 3B, there are two diagonally oriented struts 20, which extend from the distal end corners of the extension plate 16 and meet at the center of the extension plate 16 (e.g., half-way between the opposing shorter sides of the extension plate). These two struts in turn form a triangle with the distal end side of the extension plate, thereby providing a configuration that allows the extension plate to safely transfer weight and forces (e.g., derived from the main body and/or other objects stacked on top of the extension plate) to its foundation. In some embodiments, the bottom surface 18 may have a strut 20 running down the center of the extension plate 16 (FIG. 3B). The center strut may run through the point where the two diagonally oriented struts meet, to further reinforce the extension plate and inhibit any bending in the extension plate.

A cutout or aperture 22 may be formed through the extension plate 16 near the distal side of the extension plate. The aperture 22 forms a handle with which the base 10 (main body 12, extension plate 16 and counter plate 24) can be carried around. As shown in FIGS. 1, 2 and 3A-3B, the aperture 22 has a racetrack or stadium geometry. In some embodiments, the length of the straight sides of the racetrack shape of the aperture is approximately 4.7 inches or 120 mm. For each semicircle of the racetrack shape, the respective center is positioned 1 inch or 25.4 mm away from the distal end of the extension plate along a line perpendicular to the distal end. In other embodiments, the aperture 22 may be dimensioned differently (e.g., longer and/or wider) to accommodate different size hands. It is noted that the aperture 22 does not interfere with the effectiveness of the struts 20 formed in the bottom surface 18.

In some embodiments, the base 10 includes another extension or counterbalance plate 24 which provides additional stability to the main body and prevents tipping of the main body and the stand as a whole. The counterbalance plate 24 may also be, or at least function as, a foot plate with which a person can use his/her foot to push and slide the base 10 underneath an object (e.g., audio/sound equipment, desks, tables). The plate 24 is solid and extends from the main body 12 on a side opposite the extension plate 16 (FIGS. 3A-3D). For example, where the main body is rectangular, the plate 24 is positioned along the longer side of the body that does not include the extension plate 16. Given this configuration, the plate 16 inhibits the stand from tipping in one direction, while the plate 24 inhibits tipping in the opposite direction. The plate 24 is connected to the main body 12 so that it extends perpendicularly relative to the corresponding side surface 15. In other embodiments, the plate 24 and the corresponding side surface 15 form an angle slightly greater than 90 degrees therebetween (FIGS. 3C-3D).

The counterbalance plate 24 is designed in the shape of a semicircle or a segment of a circle (circular arc). Like the extension plate 16, the plate 24 has a substantially shorter height than that of the main body 12, as shown in FIGS. 3C and 3D. For example, the plate 24 has a height less than or equal to ½ inch. In a preferred embodiment, the height of the plate 24 is approximately ¼ inch or 6 mm. It is noted that the extension plate and the counterbalance plate may have the same height or different heights. Also shown in FIGS. 3C and 3D, the amount the counterbalance plate extends out from the main body is less than the amount the extension plate extends out from the main body. The furthest point along the circular arc of the counterbalance plate, for example, is approximately 2 inches or 50.2 mm away from the main body. Given the shape and dimensions of the plate 24, this part of the base is characterized with a low-profile so that it is not a trip-hazard.

Although FIGS. 3A-3E show that the counterbalance plate 24 has a semicircular or circular arc shape, the plate may comprise other shapes. Irrespective of its shape and dimensions, the plate 24 may be permanently attached to the main body 12 (e.g., soldered, brazed, welded, or molded together) or releasably connected thereto. By providing a releasable connection between the counterbalance plate 24 and the main body 12, the base—and the stand as a whole—can be disassembled into smaller pieces made easier for packing and transporting.

In some embodiments, the bottom surface 26 of the counterbalance plate 24 is even and flush with the bottom surface 14 of the main body 12, thereby providing an uninterrupted, planar surface which contacts the ground or floor (FIGS. 3C-3D). The bottom surface 26 may comprise one or more struts or posts 28 to form a planar truss embedded in the surface. In the exemplary configuration of FIG. 3B, there is one strut 28 oriented perpendicular to the main body 12 and stretching to the furthest point along the circular arc of the plate 24. The strut(s) 28 are configured to transfer weight and forces exerted on the main body to the foundation of the counterbalance plate and inhibit any bending therein.

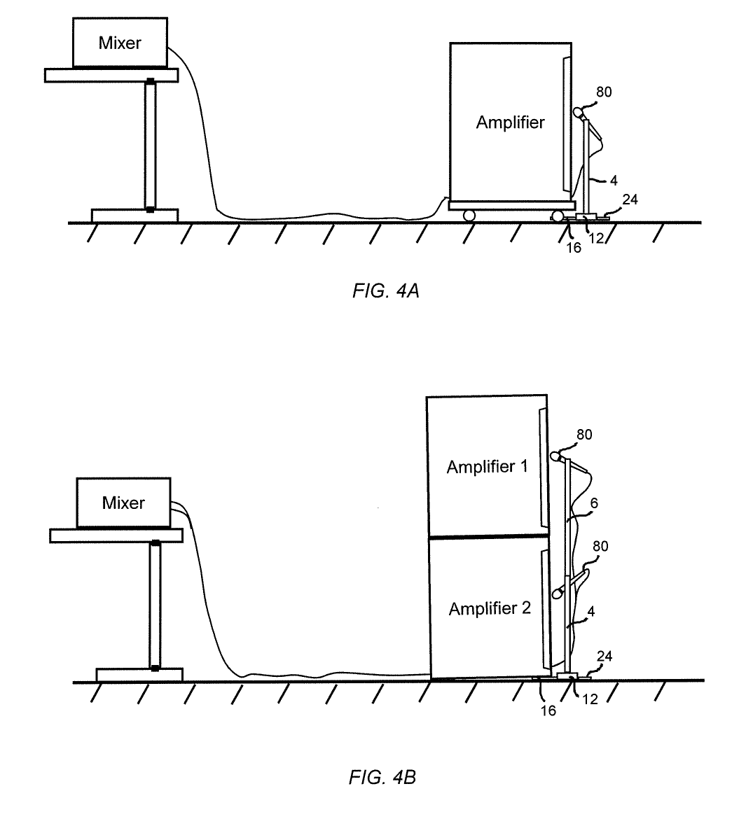

In some embodiments, the main body 12, extension plate 16 and/or counterbalance plate 24 include foot pads 30 (FIG. 5), which absorb any shocks in the ground and minimize transfer of vibrations or shocks through the base 10 into the shafts 4, 6, 8. The foot pads 30 also help reduce any damage to the stage floor during assembly of the stand 2. In preferred embodiments, the foot pads 30 are made of a damping material, such as rubber. As shown in FIG. 3B, two foot pads 30 are disposed along the shorter sides of the main body 12. The extension plate 16 may include two foot pads disposed at its distal corners. The counterbalance plate 24 may also include two foot pads disposed along its perimeter. Although the number of foot pads is six in FIGS. 2 and 3B, the base 10 may include more or less foot pads.

The main body 12 includes one or more fasteners 32, each configured to releasably couple and secure a shaft to the base 10. FIGS. 1-3 show an embodiment of the base having three fasteners 34, 36, 38 disposed collinear and at the top surface 13 of the body 12, wherein the fasteners respectively couple shafts 4, 6, 8 to the body 12. However, in some embodiments, only one fastener (for example, fastener 34) is provided in the center of the main body. Other embodiments of the base include only two fasteners (for example, fasteners 36, 38) located proximate to the ends of the main body 12. The body 12 may include more than three fasteners (e.g., four, five, etc.) distributed across the top surface 13 of the main body 12. It is noted that the more fasteners the main body has, the length of the main body must be increased to provide adequate spacing between each fastener and the corresponding shafts coupled thereto. To ensure adequate spacing, the fasteners are separated from one another by a distance equal to or greater than a diameter of the shafts or a diameter of the fasteners (FIG. 3A). For example, the fasteners may be separated from one another by a distance that is twice or three times the diameter of the fasteners.

As shown in FIG. 3C, each fastener may comprise an opening, such as a threaded screw hole or bore 40 configured to receive complementary threads on a proximal end of the shaft 4, 6, 8. By inserting and rotating the proximal end of the shaft relative to the fastener, the base and shaft are securely coupled to one another. In some embodiments, the bore 40 may be configured to receive a threaded shaft lug 42 extending from the proximal end of the shaft. Such threaded shaft lug and complementary bore are described in commonly owned U.S. Application Ser. No. 62/281,620, the disclosure of which is herein incorporated by reference in its entirety. The length of the bore 40 is equal to or greater than the length of the threaded portion of the threaded shaft lug 42. In other embodiments, the fastener may be configured to couple to a pivot-adjustable “rocker” clutch mounted at the proximal end of the shaft. Such pivot-adjustable clutch is described in commonly owned U.S. application Ser. No. 15/183,127, the disclosure of which is herein incorporated by reference in its entirety. The rocker clutch provides for articulation of the shaft relative to the base 10, such that the shaft may be perpendicular to the base in one state and may be non-perpendicular to the base in other states. For example, the bore of the fastener is configured to couple with the clutch so that the shaft can be rotated to a position where the axis of the shaft is non-perpendicular (e.g., 75 degrees) to the base. As a result, the position of the microphone attached at the top of the shaft may be positioned away, in a horizontal direction, from the main body 12. The clutch is a friction clutch and thus is able to hold the shaft at an adjusted angle.

In some embodiments, each fastener comprises a bayonet connector. For example, the proximal end of the shaft includes a cylindrical male side with one or more radial pins, while the fastener in the main body 12 includes a female receptor with matching L-shaped (or substantially L-shaped) slots and with springs to keep the two parts locked together. In yet other embodiments, the fastener may simply be a non-threaded bore configured to receive the proximal end of the shaft. Other fastening mechanisms may be implemented by the fasteners 34, 36, 38. It is noted that the fasteners 34, 36, 38 may comprise different fastening mechanisms and are not limited to each having the same fastening mechanism. Still, in other embodiments of the present teachings, one or more of the shafts 4, 6, 8 may be permanently attached to the main body 12. Although the fasteners 34, 36, 38 are described as a bore or a female receptor, other embodiments of the present teachings provide a reverse configuration where the fasteners comprise the threaded shaft lug, pivot-adjustable clutch or male component, and the proximal ends of the shafts comprise the threaded bore or female receptor.

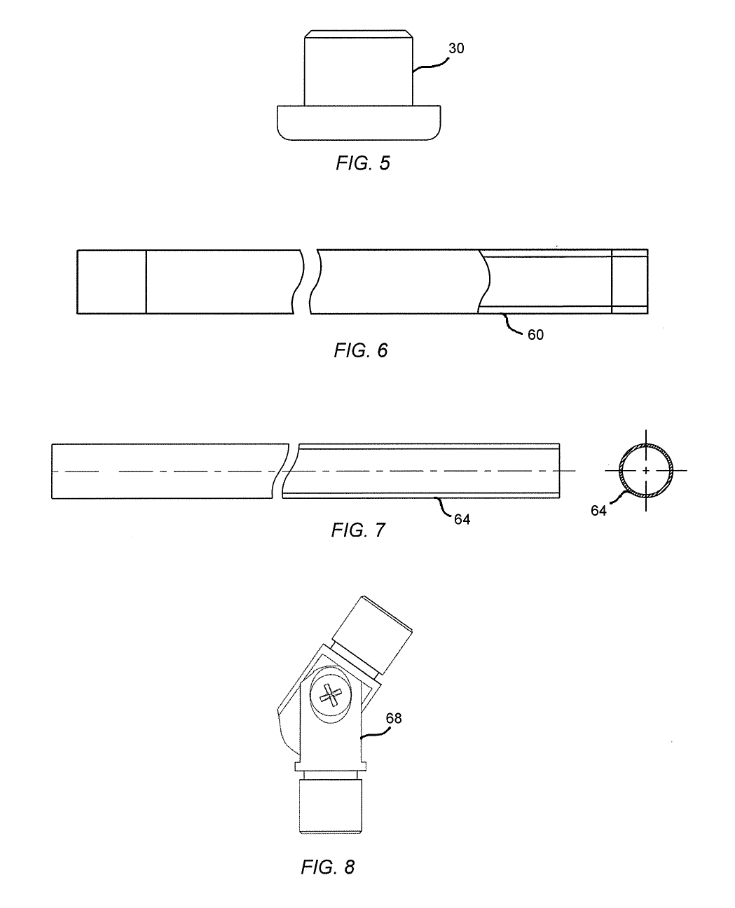

FIG. 2 shows other components of the stand 2, and in particular components relating to the shafts. For simplicity, the shaft 4 is only shown in FIG. 2, but shafts 6 and 8 have the same or similar features described below with respect to shaft 4. Also for simplicity, a few of the shaft components are only described herein below. The shaft may comprise a lower tube 60 (FIG. 6) and an upper tube 62 that are telescopically interengaged. The upper tube 62 includes a first section 64 (FIG. 7) and a second section 66 (FIG. 9), wherein the first section 64 is connected to the second section 66 via a clutch 68 (FIG. 8). The clutch 68 provides rotation of the second section 66 relative to the first section 64. For example, as shown in FIG. 2, the second section 66 has been rotated relative to the first section 64 about the clutch 68 so that an axis of the second section bisects the axis of the first section. The configuration of the lower tube, upper tube, first and second sections of the upper tube, and the clutch is described in further detail in commonly owned U.S. application Ser. No. 15/183,127, the disclosure of which is herein incorporated by reference in its entirety.

The shaft includes an adjustment collar 70 (FIG. 10) between the lower tube 60 and the upper tube 62. The collar 70 can be biased to an open position by rotating the collar in a first rotational direction around the axis of the lower tube 60. In the open position, the upper tube can telescope further into or further out of the lower tube, thereby adjusting the height of the overall stand. The adjustment collar 70 can be biased to a closed position by rotating the collar in a second rotational direction, which is opposite the first rotational direction. When the collar 70 is rotated in the second rotational direction, the collar actuates a clamp 72 (FIG. 11) to releasably affix the lower tube 60 and the upper tube 62 in positions of relative extension.

n mounting clip (e.g., microphone clip) is coupled to a distal end of the second section 66 of the upper tube 62. A microphone 80 is received in the clip and is rotatable relative to the second section 66, via a clutch, around an axis perpendicular to the second section 66.

In the stand according to the present teachings, multiple shafts may be mounted to only one base. This provides a more efficient configuration and saves space and less time for assembly and disassembly of the stand. With multiple shafts 4, 6, 8 on a single base 10 and each shaft capable of holding a microphone 80 at different heights and orientations, the stand according to the present teachings may be used to pick up the complete sound coming from one amplifier or pick up sounds coming from two or more amplifiers (FIGS. 4A-4B). Additionally, the stand according to the present teachings may be used for one or more musicians (e.g., guitarists, drummers, percussionists, keyboard players, bass players, vocalists). The same concept applies for audio or sound equipment. For example, the base can support three independent shafts, wherein a first shaft is configured for holding the guitarist's instrument, a second shaft secures a microphone for vocals, and a third shaft is configured to hold a tablet or music rest for holding sheet music. The stand is therefore multi-functional.

The present disclosure describes aspects of the invention with reference to the exemplary embodiments illustrated in the drawings; however, aspects of the invention are not limited to the exemplary embodiments illustrated in the drawings. It will be apparent to those of ordinary skill in the art that aspects of the invention include many more embodiments. Accordingly, aspects of the invention are not to be restricted in light of the exemplary embodiments illustrated in the drawings. It will also be apparent to those of ordinary skill in the art that variations and modifications can be made without departing from the true scope of the present example, in some instances, one or more features disclosed in connection with one embodiment can be used alone or in combination with one or more features of one or more other embodiments.

1. A base configured for a bottom of a stand, the base comprising:
a low-profile body having a top side, a bottom side opposite the top side and faces connecting the bottom side to the top side, the top side including a substantially planar top surface, the bottom side including a substantially planar bottom surface, and the faces each having a substantially planar facial surface;
at least one fastener positioned at the top side of the body, the fastener being configured to couple at least one shaft to the body in a raised orientation; and
a solid primary plate extending out from one of the faces of the body in a first direction, the primary plate being flat and having an upper surface and a lower surface that are substantially planar, the lower surface of the primary plate and the bottom surface of the bottom side of the body provide an even surface, a height of the primary plate from the lower surface to the upper surface being less than a height of the body from the bottom surface to the top surface;
wherein a length of the primary plate in a second direction, which is perpendicular to the first direction, is less than a length of the body in the second direction.

2. The base of claim 1, wherein a portion of the bottom side of the body is recessed so that a hollow concave cavity is formed in the body.

3. The base of claim 1, wherein the primary plate comprises a rectangular shape.

4. The base of claim 1, wherein the primary plate has a proximal end that is connected to the body and a distal end opposite the proximal end, and
wherein an aperture is formed through the primary plate proximate to the distal end of the primary plate, the aperture extends from the upper surface to the lower surface of the primary plate, and the aperture is configured as a handle for carrying the base.

5. (canceled)

6. The base of claim 1, further comprising at least one strut embedded in the lower surface of the primary plate, the at least one strut providing resistance to bending and compression in the primary plate.

7. The base of claim 6, wherein three struts are embedded in the lower surface of the primary plate;
first and second struts are positioned diagonally such that they extend from distal end corners of the primary plate and meet at a point along a center axis of the primary plate; and
a third strut is positioned on the center axis such that it extends from a proximal end of the primary plate and runs through the point where the first and second struts meet.

8. The base of claim 1, further comprising:
a solid secondary plate disposed on a side of the body opposite the primary plate, the secondary plate extending out from another of the faces of the body;
wherein the secondary plate has an upper surface and a lower surface that are substantially planar, the lower surface of the secondary plate is even with the bottom surface of the body; and
wherein a height of the secondary plate from the lower surface to the upper surface of the secondary plate is less than a height of the body from the bottom surface to the top surface of the body.

9. The base of claim 8, wherein the height of the secondary plate is the same as the height of the primary plate.

10. The base of claim 8, wherein the secondary plate has a proximal end that is connected to the body and a distal end opposite the proximal end; and
wherein the secondary plate is in a shape of a circular segment.

11. The base of claim 8, wherein the secondary plate has a proximal end that is connected to the body and a distal end opposite the proximal end; and
wherein the base further comprises at least one post embedded in the lower surface of the secondary plate, wherein one of the at least one post extends from the proximal end to a distal end of the secondary plate.

12. (canceled)

13. The base of claim 1, further comprising a plurality of foot pads disposed on the bottom surface of the body and the lower surface of the primary plate, wherein the foot pads are made of a damping material configured to minimize transfer of vibrations or shocks through the body and the primary plate to the at least one shaft.

14. The base of claim 1, wherein the at least one fastener comprises a threaded bore configured to receive a complementary threaded shaft or lug disposed at a proximal end of the shaft.

15. The base of claim 1, wherein the height of the body is less than 2 inches.

16. A base configured for a bottom of a stand, the base comprising:
a low-profile body having a top side, a bottom side opposite the top side and faces connecting the bottom side to the top side, the top side including a substantially planar top surface, the bottom side including a substantially planar bottom surface, and the faces each having a substantially planar facial surface;
multiple fasteners positioned at the top side of the body, each fastener being configured to independently couple a shaft to the body in a raised orientation; and
a solid primary plate extending out from one of the faces of the body in a first direction, the primary plate being flat and having an upper surface and a lower surface that are substantially planar, the lower surface of the primary plate and the bottom surface of the bottom side of the body provide an even surface, a height of the primary plate from the lower surface to the upper surface being less than a height of the body from the bottom surface to the top surface;
wherein a length of the primary plate in a second direction, which is perpendicular to the first direction, is less than a length of the body in the second direction.

17. The base of claim 16, wherein the fasteners are spaced apart from one another by a distance that is equal to or greater than a diameter of the fasteners.

18. The base of claim 16, wherein the fasteners are collinear.

19. The base of claim 16, further comprising:
a solid secondary plate disposed on a side of the body opposite the primary plate, the secondary plate extending out from another of the faces of the body;
wherein the secondary plate has an upper surface and a lower surface that are substantially planar, the lower surface of the secondary plate is even with the bottom surface of the body; and
wherein a height of the secondary plate from the lower surface to the upper surface of the secondary plate is less than a height of the body from the bottom surface to the top surface of the body.

20. A stand assembly, comprising:
at least one shaft having a proximal end and a distal end; and
a single base including
a low-profile body having a top side, a bottom side opposite the top side and faces connecting the bottom side to the top side, the top side including a substantially planar top surface, the bottom side including a substantially planar bottom surface, and the faces each having a substantially planar facial surface;
multiple fasteners positioned at the top side of the body, the fasteners being spaced apart from one another by a distance that is equal to or greater than a diameter of the fasteners; and
a solid primary plate extending out from one of the faces of the body in a first direction, the primary plate having an upper surface and a lower surface that are substantially planar, the lower surface of the primary plate forming an even surface with the bottom surface of the bottom side of the body, a height of the primary plate from the lower surface to the upper surface being less than a height of the body from the bottom surface to the top surface;
wherein the proximal end of the at least one shaft is releasably connected to one of the fasteners to support the at least one shaft in an raised orientation; and
wherein a length of the primary plate in a second direction, which is perpendicular to the first direction, is less than a length of the body in the second direction.

21. The stand assembly of claim 20, wherein the at least one shaft comprises three shafts;
wherein the multiple fasteners comprises three fasteners; and
wherein each of the three shafts is releasably connected to one of the three fasteners, each of the three shafts being independently supported in a raised orientation by the base.

22. The base of claim 1, wherein the primary plate is configured to slide at least partially under audio equipment.

23. The base of claim 16, wherein the fasteners are configured to couple multiple shafts to the body simultaneously, and wherein the body is weighted to support the multiple shafts simultaneously.

24. The base of claim 19, wherein the secondary plate has a shape of a circular segment.

25. The stand assembly of claim 20, wherein the at least one shaft is configured to hold a musical instrument.

26. A stand assembly, comprising:
three shafts each having a proximal end and a distal end, one of the three shafts includes:
a first tube; and
a second tube, a portion of which is received in the first tube such that the second tube telescopes into the first tube, the second tube comprising a first section and a second section, the first section and the second section being connected via a clutch, the clutch being configured to enable articulation of the second section relative to the first section about the clutch; and
a single base including:
a low-profile, rectangular body having a top side, a bottom side opposite the top side and four faces connecting the bottom side to the top side, the top side including a substantially planar top surface, the bottom side including a substantially planar bottom surface, and the faces each having a substantially planar facial surface;
three fasteners positioned at the top side of the body, the fasteners being spaced apart from one another by a distance that is equal to or greater than a diameter of the fasteners;
a solid, rectangular primary plate extending out from a first face of the body in a first direction, the primary plate having an upper surface and a lower surface that are substantially planar, the lower surface of the primary plate forming an even surface with the bottom surface of the bottom side of the body, a height of the primary plate from the lower surface to the upper surface being less than a height of the body from the bottom surface to the top surface; and
a solid secondary plate disposed on a side of the body opposite the primary plate, the secondary plate having a shape of a circular segment, the secondary plate extending out from a second face of the body by an amount less than an amount which the primary plate extends outs from the first face, a height of the secondary plate from the lower surface to the upper surface of the secondary plate being less than a height of the body from the bottom surface to the top surface of the body;
wherein the proximal ends of the shafts are releasably connected to the fasteners to support the shafts in an raised orientation, the fasteners being configured to simultaneously couple the shafts to the body simultaneously;
wherein a length of the primary plate in a second direction, which is perpendicular to the first direction, is less than a length of the body in the second direction; and
wherein a first shaft of the three shafts is configured to hold a microphone and a second shaft of the three shafts is configured to hold a musical instrument.
